(19) United States
(12) Patent Application Publication
(10) Pub. No.: US 2015/0167950 A1
(43) Pub. Date: Jun. 18, 2015

(54) METHOD AND SYSTEM FOR A THERMAL CUT-OFF USING LOW-TEMPERATURE SOLDER FOR A SOLID STATE LIGHTING DEVICE

(71) Applicant: GE LIGHTING SOLUTIONS, LLC, East Cleveland, OH (US)

(72) Inventors: Kevin Carr Payne, Brecksville, OH (US); Josip Brnada, Willoughby, OH (US)

(73) Assignee: GE LIGHTING SOLUTIONS, LLC, East Cleveland, OH (US)

(21) Appl. No.: 14/108,386

(22) Filed: Dec. 17, 2013

(51) Int. Cl. F21V 25/10; H01H 37/32; H02H 5/04

(52) U.S. Cl. CPC F21V 25/10; H02H 5/047; H01H 37/32

(57) ABSTRACT

In some embodiments, a method and system including a component of a lighting device; a first electrical conductor coupled to the component of the lighting device; a tensioned electrical conductor; and an electrically conductive connection structure coupling the first electrical conductor to the tensioned electrical conductor, the connection structure reflowing to decouple the first electrical conductor from the tensioned electrical conductor in response to the connection structure being subjected to a thermal load exceeding a predetermined threshold melting point.

### BACKGROUND

Electric and electronic circuits may operate most reliably at temperatures lower than a certain threshold. The particular threshold for a given circuitry may vary depending the components comprising and the configuration of the circuitry. Some electrical device packaging may result in a high heat density and elevated operating temperatures within the device packaging. It is known that higher operating temperatures can decrease the life cycle of electrical and electronic devices, resulting in devices and components degrading quicker than desired. In some contexts, exposure to higher temperatures may alter the electrical characteristic(s) (e.g., a resistance) of the components within a device such that the performance of the device is degraded. In some contexts, an excessive temperature may increase the risk of component melting, a fire, or other catastrophic failure.

While a great deal of effort and expense has been devoted to researching, developing, and deploying systems and devices to dissipate heat in electrical and electronic equipment, thermal overload conditions may still occur. Thus, it remains essential to minimize or eliminate exposing electrical circuits to unsafe temperatures. Therefore, it would be desirable to provide systems and methods for efficiently providing thermal protection to electrical circuitry.

### BRIEF DESCRIPTION OF THE DRAWINGS

Features and advantages of some embodiments of the present invention, and the manner in which the same are accomplished, will become more readily apparent upon consideration of the following detailed description of the invention taken in conjunction with the accompanying drawings, wherein:

FIG. 1 is an illustrative depiction of a thermally protected circuit, according to some embodiments herein;

FIG. 2 is an illustrative depiction of a thermally protected circuit after being exposed to a thermal overload, according to some embodiments herein;

FIG. 3 is a flow diagram of a process, in accordance with some embodiments herein; and

FIG. 4 is a schematic diagram of a system, in accordance with some embodiments herein.

### DETAILED DESCRIPTION

FIG. 1 is an illustrative depiction of a thermally protected system 100, according to some embodiments herein. System 100 is representative, in general, of a system including a thermal protection mechanism of the present disclosure. In particular, system 100 includes a metal core printed circuit board (MCPCB) 105 and a conductive contact pad 110. In general, MCPCB 105 may be referred to as a component of a lighting device to be protected and contact pad 110 may be referred to herein as, in general, a first electrical conductor. In the present example of FIG. 1, MCPCB 105 may be a component of a lighting device or system that supports contact pad 110. In some instances, contact pad 110 may comprise a conductive pad, an electrical trace, an electrical via or throughhole, wire, or some other conductive pathway. System 100 generally forms at least a portion or a subsystem of a lighting device, fixture, system, or component.

System 100 further includes a tensioned electrical conductor 115. The tensioned electrical conductor is in electrical communication with the first electrical conductor of system 100 by virtue of an electrically conductive connection structure 120 coupled to both tensioned electrical conductor 115 and first electrical conductor (e.g., contact pad) 110. In some aspects, tensioned electrical conductor 115 may have an outer insulating cover and an electrical conductor wire disposed therein. In some instances, tensioned electrical conductor 115 may be a non-insulated wire or terminal. Tensioned electrical connection 115 is considered to be “tensioned”, subject to a tension, or under tension as illustrated in FIG. 1 since the electrical conductor is forcibly held in the positioned shown in FIG. 1. The connection structure 120 operates to forcibly hold tensioned electrical conductor 115 in the position shown in FIG. 1. In some aspects herein, tensioned electrical conductor 115 may be referred to simply as electrical conductor 115.

Connection structure 120 has a number of characteristics that are relevant to the present disclosure. First, the connection structure is electrically conductive. This characteristic is relevant since it ensures that the connection structure may provide an electrically conductive path between tensioned electrical conductor 115 and the first electrical conductor 110 of system 100. Secondly, the connection structure has a predetermined threshold melting point. The threshold melting point is the temperature at which connection structure 120 melts (i.e., transitions from a solid state to a liquid state). The threshold melting point of the connection structure may be determined based on the chemical composition of the material (e.g., an alloy) comprising the connection structure. The process of determining a characteristic melting point of a material is known, thus it will not be discussed herein.

Tensioned electrical conductor 115 may be placed into the position depicted in FIG. 1 at a time when connection structure 120 is at a temperature in excess of its threshold melting point and is a liquid. Upon cooling to a temperature lower than its threshold melting point, connection structure 120 becomes a solid and forcibly holds or retains tensioned electrical conductor 115 in the position shown in FIG. 1, or in some other tensioned position.

In some aspects, a measure of tension may be placed on or forced upon tensioned electrical conductor 115 either before or after the electrical conductor is coupled to the first electrical conductor 110 of FIG. 1. In some aspects, some manufacturing processes may be (relatively) simplified by subjecting electrical conductor 115 to the tension (i.e., force) after the electrical conductor is coupled to the first electrical conductor of FIG. 1. In the example of FIG. 1, a support device 125, configured as shown, imparts an upward force on electrical conductor 115. The upward force on electrical conductor 115 tends to urge electrical conductor 115 upwards and away from connection structure 120. However, since connection structure 120 is a solid material, electrical conductor 120 is unable to move upwards and away from connection structure 120 under the circumstances depicted in FIG. 1.

In some embodiments, a tension on the tensioned electrical conductor is provided by at least one of an intrinsic characteristic of the tensioned electrical conductor (not shown) and a relative spatial configuration of the first electrical conductor (e.g. contact pad 110), the tensioned electrical conductor 115, and the connection structure 125, as demonstrated in FIG. 1.

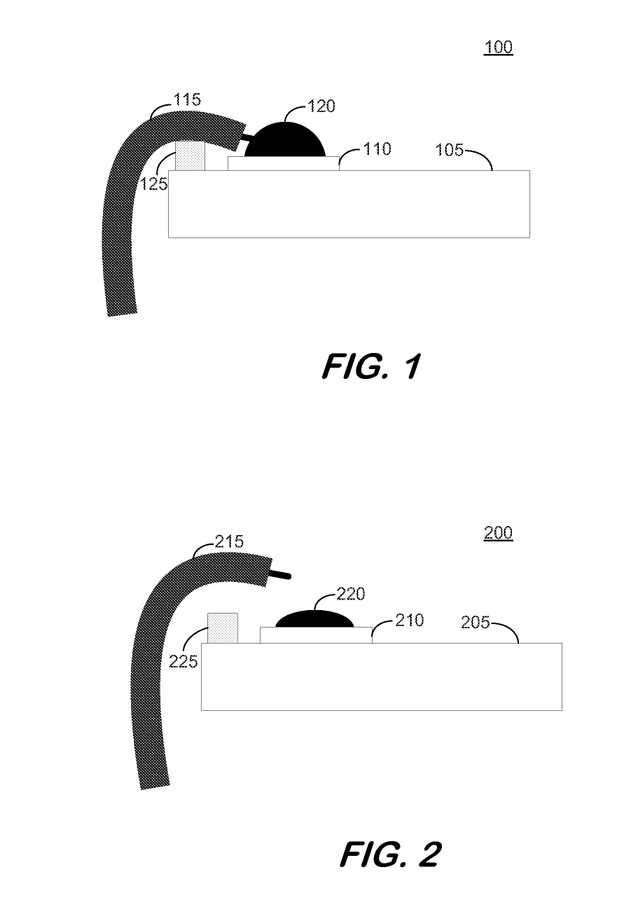

Referring to FIG. 2, there is shown an illustrative depiction of a thermally protected system 200, according to some embodiments herein. System 200 may in large part be similar to system 100 of FIG. 1 and is representative, in general, of a system including a thermal protection mechanism of the present disclosure in an instance the system has been exposed to a thermal load greater than the threshold melting point of the connection structure. System 200 includes a component of a lighting device (i.e., MCPCB 205 to be protected) and a conductive contact pad 210 (the “first electrical conductor”), a tensioned electrical conductor 215, an electrically conductive connection structure 220, and a support structure 225. The components of FIG. 2 may operate and behave the same as or similar to the corresponding items in FIG. 1. Accordingly, an understanding of FIG. 2 may be clearly had by referring to the detailed discussion of system 100 in FIG. 1 above.

In contrast to FIG. 1, connection structure 220 of FIG. 2 is shown after it has been subjected to a temperature in excess of its known (i.e., predetermined) melting temperature. As such, connection structure 220 reflows or melts. When the connection structure reflows it no longer retains or holds tensioned electrical conductor 115 in the tensioned position shown in FIG. 1. Tensioned electrical conductor 115, being urged upwards by the tension forces acting thereon, at least in part by support device 225, becomes decoupled from the first electrical conductor 210. Tensioned electrical conductor 215 may, at least in part, be urged to move upwards due to the physical configuration of the components of FIG. 2 and/or some intrinsic characteristics of the tensioned electrical conductor.

In some aspects, decoupling electrical conductor 215 from the first electrical conductor 210 may operate to provide an “open” circuit condition or a disconnect in a circuit including electrical conductor 215 and the first electrical conductor 210 shown in FIG. 2. Opening or disconnecting the circuit may operate to interrupt at least one of a voltage or a current to an electrical component (not necessarily shown in FIGS. 1 and 2). In some instances, the interrupted voltage or current may be (per FIG. 1) supplied to the component of the lighting device comprising, for example, MCPCB 105/205.

In some aspects, the predetermined threshold melting point of the connection structure 120, 220 may be the same as or nearly the same as (i.e., close to) a safe operating temperature for the lighting device component 105, 205 of FIGS. 1 and 2 or another component (not shown in FIGS. 1 and 2). The determining of the safe operating temperature for the lighting component of FIGS. 1 and 2 or other component(s) (not shown) may be determined by known conventional methods and will thus not be discussed in detail herein. For example, if the maximum safe operating temperature for the lighting component of FIGS. 1 and 2 is about 105° C. (Celsius), then the composition of the material comprising connection structure 120, 220 may be chosen to have a threshold melting point of about 105° C. In some instances, the threshold melting point of connection structure 120, 220 may be less than about 105° C. to further safeguard or provide a margin of safety against a potentially unsafe operating condition.

In some embodiments, the connection structure 120, 220 may comprise a solder material. A composition of the solder material may be selectively structured to achieve characteristics compatible with aspects herein. For example, the solder material may be constructed to have a desired threshold melting point no greater than the safe operating characteristic or condition of a component or device to be protected from a thermal overload or other condition. In some aspects, the lighting component or device to be protected from the thermal overload or other condition may include the lighting device component including, for example, MCPCB 105, 205. However, in some embodiments, the component or device to be protected from the thermal overload or other condition may include other features not depicted in FIGS. 1 and 2, including component(s) and device(s) that may not be directly connected to the first electrical conductor 110, 210 via the connection structure.

In some embodiments, the component or device to be protected from a thermal overload or other condition may include other features that are separate from the components comprising or even directly connected to the first electrical conductor 110, 210 shown in FIGS. 1 and 2. In this aspect, the thermal protection feature(s) of the present disclosure may be incorporated in one part of a device or system and yet provide protection to another system, device, component, or at least a part thereof. In some aspects, the component or device to be protected from a thermal overload or other condition herein need not be electrically connected to the electrical conductor or even electrically conductive.

In some embodiments, the component(s) to be protected from a thermal overload or condition may, in general, be any component of a lighting system or device. In some aspects, the component(s) to be protected from a thermal overload or other condition may be a MCPCB (105, 205), a heatsink, a light engine for a LED or other lamp(s), a lens, an optical diffuser, an optical reflector, electrical components, connectors or fasteners, non-electrical (i.e., non-conductive) devices, an ambient temperature, and a combination thereof.

In some aspects, future systems and devices may be designed to include the thermal and other protection feature(s) of the present disclosure. In some aspects, existing or legacy components, systems, and devices may be modified or upgraded to incorporate the thermal and other protection feature(s) of the present disclosure. In some instances, the modifications and/or upgrading may include using (replacing) a connection structure (e.g., solder material) with the characteristics disclosed herein. In some instances, the modifications and/or upgrading may include placing an electrical conductor under a measure or amount of tension, with or without the use of a support structure. In some instances, the modifications and/or upgrading may include a combination of adaptations of a lighting component, system, and device. In some aspects, the modifications and/or upgrading may be efficiently implemented since an embodiment of the thermal overload and other protection system and method herein may include a single terminal of a tensioned electrical conductor that interfaces with and connects to first electrical conductor via an electrically conductive connection structure. The single terminal conductor may make placement of the connection structure herein relatively easy, as well as offer configuration flexibility and cost efficiencies.

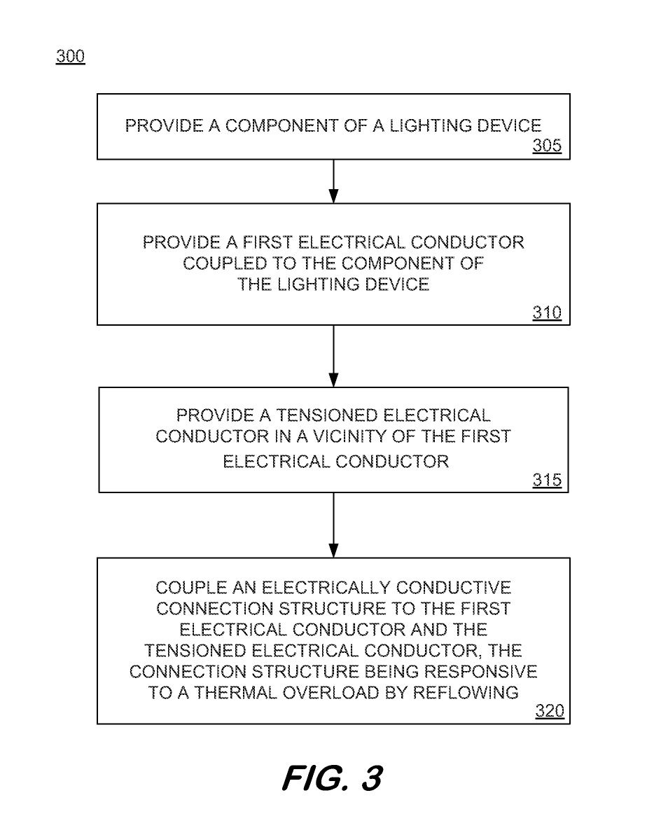

FIG. 3 is a flow diagram of a process 300, in accordance with some aspects herein. For example, operation 305 includes providing a component of a lighting device. The lighting device component may comprise at least one device, subsystem, or component of a lighting system. In some embodiments, the lighting device component may include one or more of a MCPCB or other type of PCB, a device housing, a lamp housing, a heatsink, a light engine for a LED or other lamp(s), a lens, an optical diffuser, an optical reflector, electrical components, connectors or fasteners, non-electrical (i.e., non-conductive) devices, an ambient temperature, and a combination thereof

Operation 310 may comprise providing a first electrical conductor coupled to the component of the lighting device. In some embodiments, the first electrical conductor may be coupled to the lighting device component by an electrically conductive connection. In some embodiments, the first electrical conductor may be coupled to the lighting device component by at least one of a thermally conductive connection and an electromagnetic signal conductive connection (e.g., wireless communication signal, a modulated light signal, etc.).

Operation 315 includes providing a tensioned electrical conductor in a vicinity of the first electrical conductor. The tensioned electrical conductor should be in the vicinity of the first electrical circuit since it will interface or connect to the electrical conductor. However, it is noted that the tensioned electrical conductor of operation 315 need not be a part of the first electrical conductor discussed in operation 310 or the lighting component introduced in operation 305.

Operation 320 includes coupling an electrically conductive connection structure (e.g., solder material) to both the tensioned electrical circuit and the first electrical conductor to provide an electrically conductive connection between the tensioned electrical conductor and the first electrical conductor. In accordance with aspects herein, the connection structure is electrically conductive and has a predetermined threshold melting point where, in response to the connection structure being subjected to a thermal load exceeding the predetermined threshold melting point thereof, the connection structure reflows (i.e., at least partially melts) to decouple the electrical conductor from the electrical circuit.

In accordance with aspects herein, when the connection structure reflows to decouple the tensioned electrical conductor from the first electrical conductor in response to the connection structure being subjected to a thermal load (i.e., temperature) exceeding the predetermined threshold melting point (or other condition), an operation of a device or system to be protected may be disconnected from at least one of a voltage or current supply, rendered inoperable, or at least have an operating parameter of the device or system to be protected modified or altered. For example, in some embodiments, a thermal overload condition may cause the device or system being protected to stop operating in a first state (for example, (i) on, (ii) full light output from a lighting device, etc.) and start operating in a second state (e.g., (iii) off, (iv) a reduced light output from a lighting device, etc.).

In some aspects, the thermal protection provided by a device, system, or method herein may be a one-time failure protection mechanism. That is, That is, once the connection structure material reflows and releases the tensioned electrical conductor then the electrical conductor cannot be re-set. In some regards, the thermal overload protection or other trigger (e.g., the predetermined threshold melting point of the connection structure) may be chosen with care to match or mirror an actual safe operating temperature of a device, component, or system to be protected.

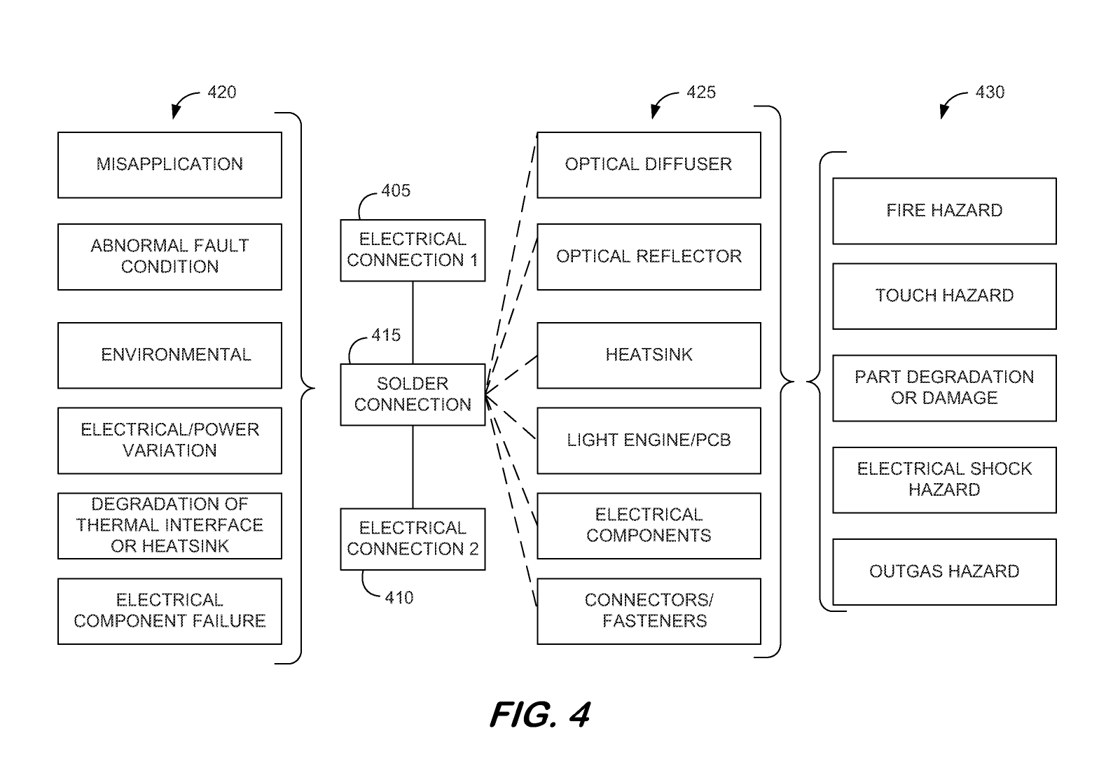

FIG. 4 is a schematic diagram of a system 400, in accordance with some embodiments herein. System 400 illustrates at least a portion, subsystem, or component of a lighting device and includes an electrical connection 1 (405) and an electrical connection 2 (410), where electrical connection 1 (405) is connected to electrical connection 2 (410) by a solder connection 415. In general, electrical connection 1 (405) may correspond to the first electrical conductor 110, 210 of FIGS. 1 and 2; electrical connection 2 (410) may correspond to the tensioned electrical conductor 115, 215 of FIGS. 1 and 2; and solder connection 415 may correspond to the electrically conductive connection structure 120, 220 of FIGS. 1 and 2, without any loss of generality.

As shown in FIG. 4, solder connection 415 (i.e., the electrically conductive connection structure), in accordance with some embodiments herein, may provide a level of protection to at least one protected component, device, or system 425. In some aspects, solder connection 415 reacts (i.e., reflows) in response to at least one trigger condition 420 to provide the level of protection to the at least one protected component, device or system (i.e., “system”) 425. The level of protection is provided to the at least one protected system 425 to avoid one or more of the conditions 430.

Referring to FIG. 4, the trigger condition(s) may include at least one of a lighting system or device misapplication; an abnormal fault condition; an environmental condition to be avoided (e.g., the release of an amount of (toxic) material into the environment; etc.); an electrical or power variation or fluctuation that exceeds a certain threshold condition; a degradation of a thermal interface, heat sink, or other heat dissipation mechanism; an electrical component failure; and combinations thereof. The trigger conditions shown at 420 are illustrative of some of the types of trigger conditions herein, not an exhaustive listing. One or more of the trigger conditions 420 may cause solder connection 415 to reflow by, for example, subjecting the solder connection to a temperature in excess of the melting point of the solder connection.

Regarding the system 425 to be protected by the solder connection 415, system 425 of FIG. 4 may correspond to the lighting device 105, 205 to be protected in FIGS. 1 and 2. FIG. 4 shows, as an example, a system 425 that includes at least one of an optical diffuser, an optical reflector, a heatsink, a light engine or PCB, electrical components, and connectors or fasteners. In general, system 425 may include one or more components of a lighting system. The systems at 425 are illustrative of some of the types of systems to be protected herein, not an exhaustive listing.

In some regards and embodiments herein, one or more of the conditions 430 to be avoided, mitigated, or at least reduced by system 400 includes a fire hazard, a “touch” hazard (e.g., too warm for (prolonged) human exposure but too cool to start a fire), at least partial degradation or damage of a device or system, an electrical shock, an outgas hazard, and combinations thereof. The conditions to be avoided 430 are illustrative of some of the conditions herein, not an exhaustive listing. Table 1 below lists a number of potential connection structure composition materials and their corresponding melting points. In some embodiments, the connection structure material may have a predetermined threshold melting point about 75 degrees Celsius to about 175 degrees Celsius. In some aspects, the connection structure comprises a solder material. The solder material may, in some embodiments herein, be selected from a group of alloys comprising Indium (In), Tin (Sn), Bismuth (Bi), Silver (Ag), Gallium (Ga), Zinc (Zn), and combinations thereof. The materials in Table 1 are not meant to be exhaustive but representative and illustrative of a range of materials that may be used to comprise a connection structure in some embodiments herein. In some instances, the particular composition of the connection structure material may be selected based, at least in part, on an application or a use-case for the lighting thermal protection system(s) and method(s) herein.

TABLE 1

| | Liquidus | Solidus |
|---|---|---|
| | Temperature | Temperature |
| Chemical Composition | (° C.) | (° C.) |
| 61Ga25In13Sn1Zn | 8 | 7 |
| 66.5Ga20.5In13Sn | 11 | 11 |
| 75.5Ga24.5In | 16 | 16 |
| 62.5Ga21.5In16Sn | 17 | 11 |
| 95Ga5In | 25 | 16 |
| 100Ga | 30 | 30 |
| 49Bi21In18Pb12Sn | 58 | 58 |
| 51In32.5 Bi16.5Sn | 60 | 60 |
| 49Bi18Pb18In15Sn | 69 | 58 |
| 66.3In33.7Bi | 72 | 72 |
| 57Bi26In17Sn | 79 | 79 |
| 54Bi29.7In16.3Sn | 81 | 81 |
| 51.45Bi31.35Pb15.2Sn 2In | 93 | 87 |
| 52Bi31.7Pb15.3Sn1In | 94 | 90 |
| 52.5Bi32Pb15.5Sn | 95 | 95 |
| 52Bi32Pb16Sn | 95.5 | 95 |
| 52Bi30Pb18Sn | 96 | 96 |
| 50Bi31Pb19Sn | 99 | 93 |
| 50Bi28Pb22Sn | 100 | 100 |
| 46Bi34Sn20Pb | 100 | 100 |
| 56Bi22Pb22Sn | 104 | 95 |
| 50Bi30Pb20Sn | 104 | 95 |
| 52.2Bi37.8Pb10Sn | 105 | 98 |
| 45Bi35Pb20Sn | 107 | 96 |
| 46Bi34Pb20Sn | 108 | 95 |
| 52.2In46Sn1.8Zn | 108 | 108 |
| 54.5Bi39.5Pb6Sn | 108 | 108 |
| 67Bi33In | 109 | 109 |
| 51.6Bi41.4Pb7Sn | 112 | 98 |
| 50Bi25Pb25Sn | 115 | 95 |
| 52.98Bi42.49Pb4.53Sn | 117 | 103 |
| 52In48Sn | 118 | 118 |
| 53.75Bi43.1Pb3.15Sn | 119 | 108 |
| 55Bi44Pb1Sn | 120 | 117 |
| 55Bi44Pb1In | 121 | 120 |
| 55.5Bi44.5Pb | 124 | 124 |
| 50In50Sn | 125 | 118 |
| 58Bi42Pb | 126 | 124 |
| 38Pb37Bi25Sn | 127 | 93 |
| 51.6Bi37.4Sn6In5Pb | 129 | 95 |
| 40In40Sn20Pb | 130 | 121 |
| 52Sn48In | 131 | 118 |
| 34Pb34Sn32Bi | 133 | 96 |
| 56.84Bi41.16Sn2Pb | 133 | 128 |
| 38.41Bi30.77Pb30.77Sn0.05Ag | 135 | 96 |
| 57.42Bi41.58Sn1Pb | 135 | 135 |
| 36Bi32Pb31Sn1Ag | 136 | 95 |
| 55.1Bi39.9Sn5Pb | 136 | 121 |
| 36.5Bi31.75Pb31.75Sn | 137 | 95 |
| 43Pb28.5Bi28.5Sn | 137 | 96 |
| 58Bi42Sn | 138 | 138 |
| 38.4Pb30.8Bi30.8Sn | 139 | 96 |
| 57Bi42Sn1Ag | 140 | 139 |
| 33.33Bi33.34Pb33.33Sn | 143 | 96 |
| 97In3Ag | 143 | 143 |
| 58Sn42In | 145 | 118 |
| 80In15Pb5Ag | 149 | 142 |
| 99.3In0.7Ga | 150 | 150 |
| 95In5Bi | 150 | 125 |
| 90In10Sn | 151 | 143 |
| 42Pb37Sn21Bi | 152 | 120 |
| 99.4In0.6Ga | 152 | 152 |
| 99.6In0.4Ga | 153 | 153 |
| 99.5In0.5Ga | 154 | 154 |
| 100In | 156.7 | 156.7 |
| 54.55Pb45.45Bi | 160 | 122 |
| 70Sn18Pb12In | 162 | 162 |
| 48Sn36Pb16Bi | 162 | 140 |
| 43Pb43Sn14Bi | 163 | 144 |
| 50Sn40Pb10Bi | 167 | 126 |
| 51.5Pb27Sn21.5Bi | 170 | 131 |
| 60Sn40Bi | 170 | 138 |
| 50Pb27Sn20Bi | 173 | 130 |
| 70In30Pb | 175 | 165 |
| 47.47Pb39.93Sn12.6Bi | 176 | 146 |
| 62.5Sn36.1Pb1.4Ag | 179 | 179 |
| 60Sn25.5Bi14.5Pb | 180 | 96 |
| 37.5Pb37.5Sn25In | 181 | 134 |
| 86.5Sn5.5Zn4.5In3.5Bi | 186 | 174 |
| 77.2Sn20In2.8Ag | 187 | 175 |
| 83.6Sn8.8In7.6Zn | 187 | 181 |
| 91Sn9Zn | 199 | 199 |
| 86.9Sn10In3.1Ag | 205 | 204 |
| 91.8Sn4.8Bi3.4Ag | 213 | 211 |
| 90Sn10Au | 217 | 217 |
| 95.8Sn3.5Au0.7Cu | 220 | 217 |
| 95.5Sn3.9Ag0.6Cu | 220 | 217 |

Embodiments have been described herein solely for the purpose of illustration. Persons skilled in the art will recognize from this description that embodiments are not limited to those described, but may be practiced with modifications and alterations limited only by the spirit and scope of the appended claims.

What is claimed is:

1. A system comprising:
a component of a lighting device;
a first electrical conductor coupled to the component of the lighting device;
a tensioned electrical conductor; and
an electrically conductive connection structure coupling the first electrical conductor to the tensioned electrical conductor, the connection structure reflowing to decouple the first electrical conductor from the tensioned electrical conductor in response to the connection structure being subjected to a thermal load exceeding a predetermined threshold melting point of the connection structure.

2. The system of claim 1, wherein a tension on the tensioned electrical conductor is provided by at least one of an intrinsic characteristic of the tensioned electrical conductor and a relative spatial configuration of the first electrical conductor, the tensioned electrical conductor, and the connection structure.

3. The system of claim 1, further comprising a support structure to impart tension to the tensioned electrical conductor.

4. The system of claim 1, wherein at least one of a current and a voltage to the first electrical conductor is interrupted when the tensioned electrical conductor is decoupled from the first electrical conductor.

5. The system of claim 1, further comprising a component to be protected from a thermal overload.

6. The system of claim 5, wherein the component to be protected from the thermal overload includes, at least, the component of the lighting device.

7. The system of claim 5, wherein the component to be protected from the thermal overload is at least one of the following: a metal core printed circuit board, a heatsink, a light engine, a lens, an optical reflector, an optical diffusor, an electrical component, a connector or fastener, and a combination thereof.

8. The system of claim 5, wherein the tensioned electrical conductor is not electrically connected to the component to be protected.

9. The system of claim 1, wherein the predetermined threshold melting point of the connection structure is about 75 degrees Celsius to about 175 degrees Celsius.

10. The system of claim 1, wherein the connection structure comprises a solder material.

11. The system of claim 10, wherein the solder material is selected from alloys comprising Indium (In), Tin (Sn), Bismuth (Bi), Silver (Ag), Gallium (Ga), Zinc (Zn), and combinations thereof.

12. The system of claim 1, wherein the electrical conductor is a single terminal connector.

13. A method for protecting a component of a lighting device from thermal overload, the method comprising:
providing a component of a lighting device;
providing a first electrical conductor coupled to the component of the lighting device;
providing a tensioned electrical conductor; and
coupling an electrically conductive connection structure to the first electrical conductor and the tensioned electrical conductor, the connection structure reflowing to decouple the first electrical conductor from the tensioned electrical conductor in response to the connection structure being subjected to a thermal load exceeding a predetermined threshold melting point of the connection structure.

14. The method of claim 13, wherein a tension on the tensioned electrical conductor is provided by at least one of an intrinsic characteristic of the tensioned electrical conductor and a relative spatial configuration of the first electrical conductor, the tensioned electrical conductor, and the connection structure.

15. The method of claim 13, further comprising providing a support structure to impart tension to the electrical conductor.

16. The method of claim 13, wherein at least one of a current and a voltage to the first electrical conductor is interrupted when the tensioned electrical conductor is decoupled from the first electrical conductor.

17. The method of claim 13, wherein the component to be protected from the thermal overload is at least one of the following: a metal core printed circuit board, a heatsink, a light engine, a lens, an optical reflector, an optical diffuser, an electrical component, a connector or fastener, and a combination thereof.

18. The method of claim 13, wherein the predetermined threshold melting point of the connection structure is about 75 degrees Celsius to about 175 degrees Celsius.

19. The method of claim 13, wherein the connection structure comprises a solder material.

20. The method of claim 22, wherein the solder material is selected from alloys comprising Indium (In), Tin (Sn), Bismuth (Bi), Silver (Ag), Galium (Ga), Zinc (Zn), and combinations thereof.
